(19) United States
(12) Patent Application Publication
(10) Pub. No.: US 2010/0100919 A1
(43) Pub. Date: Apr. 22, 2010

(54) METHOD FOR REDUCING UPSTREAM INGRESS NOISE IN CABLE DATA SYSTEM

(76) Inventors: Jin-Jen Hsue, Hsinchu County (TW); Wei-Chih Lu, Taipei County (TW)

Correspondence Address: Muncy, Geissler, Olds & Lowe, PLLC, P.O. BOX 1364, FAIRFAX, VA, 22038-1364, US

(21) Appl. No.: 12/642,039

(22) Filed: Dec. 18, 2009

Related U.S. Application Data
(63) Continuation-in-part of application No. 11/649,858, filed on Jan. 5, 2007, now abandoned.

(51) Int. Cl. H04N 7/173

(52) U.S. Cl. 725/111; 725/125

(57) ABSTRACT

In a method of reducing and diagnosing upstream ingress noise in cable data system utilize a MAC/MAP management messages via a downstream path based on Cable Systems Interface Specification (DOCSIS) to provide precise control of gates deployed near the user side provide a powerful algorithm for CATV operators to mitigate ingress noise problem.

### CROSS-REFERENCE TO RELATED APPLICATIONS

This application is a continuation-in-part application of U.S. Ser. No. 11/649,858, filed on Jan. 5, 2007, now U.S. Publication No. 2008/0168518.

### FIELD OF THE INVENTION

The present invention relates to a method of reducing upstream ingress noise in cable data system, and more particularly to a method of reducing and diagnosing upstream ingress noise is in Hybrid fiber-coaxial (HFC) network based on Cable Systems Interface Specification (DOCSIS).

### BACKGROUND OF THE INVENTION

The use of networks has become indispensable in most people's daily life. Various high-tech network transmission systems have been developed in response to people's increasing demands for network transmission and many other applications thereof. One example of these network transmission systems is a cable data system, which has the advantages of having large bandwidth and quick transmission speed.

In a standard cable for bidirectional transmission, a bandwidth between 5 MHz and 42 MHz (in the case of American standard) or between 5 MHz and 65 MHz (in the case of European standard) is used as a return path for an upstream signal. However, the above-mentioned bandwidths fall in a zone within which signal interference frequently occurs due to all kinds of radio-frequency (RF) broadcast signals and electric wave noise sources. Meanwhile, loosened or poor-contacted indoor electrical appliance cords would also cause signal interference. As shown in FIG. 1, a cable television (CATV) network is a tree network, and all upstream noises would be returned via the network to gather and accumulated at a headend of the CATV network.

There are methods developed for reducing upstream ingress noise in a cable data system, such as dynamic noise blocking technique, upstream power pre-emphasizing technique, etc.

In the dynamic noise blocking technique, an upstream signal from a client is detected. When the upstream signal is detected as having signal energy exceeded a threshold value, the upstream signal is determined as a client upstream signal. Otherwise, the upstream signal is determined as a noise.

When an upstream signal is determined, the network is linked to allow transmission of the signal to the headend of the network. Otherwise, the network is down. In brief, the dynamic noise blocking technique utilizes digital signal processing (DSP) technique to check and determine whether a received upstream signal has energy exceeded a threshold value. It is known that the analysis of an upstream signal power requires a large amount of operation and real-time conversion, which is done with special hardware or chips, and therefore requires high cost.

In the upstream power pre-emphasizing technique, the client transmits an upstream signal with higher power, which would sometimes exceed a standard level. The high power of the upstream signal is then attenuated by specific means in a cable allocation system to a receiving range acceptable by the headend of the network. Since a signal with higher power has a high signal-to-noise ratio (SNR), the noise accompanying the signal is attenuated at the same time by the specific means in the cable allocation system. As a result, the upstream ingress noise is reduced at the headend. In the upstream power pre-emphasizing technique, it is necessary to supply an over-standard upstream power. For this purpose, the cable modems located at the clients require modification in hardware. Moreover, this technique does not comply with DOCSIS (Data over Cable System Interface Specifications).

One of prior art, Dziekan's patent (U.S. Pat. No. 6,728,887), discloses an arrangement for providing mediated access in an HFC access network, and the utilization of TTP for measuring the noise level within a channel during its vacancy period, wherein a vacant channel corresponds to a non-used TDMA slot. Any signal measured on the vacant channel is assumed to be noise. The ingress level on the vacant channel can then be measured and the SNR determined. However, the noise resulting from the vacant channel will still be accumulated at a head end of the HFC access network. In addition, the Dziekan utilizes a flow-through method for querying/monitoring repeatedly until the noise is found in the HFC access network, but above-mentioned method may cost a lot of time to find a place of the noise occurred.

Therefore, it is desirable to develop a method of reducing upstream ingress noise in cable data system, which may be implemented at low cost using easily producible hardware, and is in compliance with DOCSIS.

### SUMMARY OF THE INVENTION

A primary object of the present invention is to provide a method of reducing upstream ingress noise in cable data system, so as to solve the problem of deteriorated network transmission quality caused by ingress noise that is existed in user groups and returned via upstream network path to gather and accumulate at a CMTS or a headend of the cable data system.

To achieve the above object, one preferred embodiment of the present invention provides the method of reducing upstream ingress noise in cable data system according to the present invention comprises the following steps: (1) providing a plurality of upstream ingress noise blocking systems, each of which is mounted between a headend of the cable data system and one of a plurality of user groups; (2) causing the upstream ingress noise blocking systems and the user groups to synchronously use an upstream channel of the headend; (3) causing the upstream ingress noise blocking systems to simultaneously monitor downstream broadcast signals independently transmitted from the headend to each of the user groups, wherein each of the downstream broadcast signals includes information about data uploading time for a corresponding one of the user groups; and an upstream channel connection time schedule being determined for the upstream ingress noise blocking systems and the user groups based on the data uploading time for each of the user groups; and (4) causing the upstream ingress noise blocking systems to separately connect the corresponding user groups to the upstream channel according to the upstream channel connection time schedule, so that data from each of the user groups may be uploaded to the headend.

To achieve the above-mentioned objects, another preferred embodiment of the present invention provides a method of reducing upstream ingress noise in cable data system, and the cable data system having a plurality of groups of Cable Modems (CMs) and a Cable Modem Termination System (CMTS) based on Cable Systems Interface Specification (DOCSIS), the method of the present invention comprising the steps of: (1) disposing a plurality of DOCSIS based ingress noise blockers (DNB) respectively between the groups of CMs and the CMTS, wherein each of the ingress noise blockers has a radio frequency (RF) switch, a programmable band pass filter, and a cable modem controller; (2) monitoring a MAP/UCD management messages resulted from the CMTS in the cable modem controller, wherein the MAP management messages select one of CMs to transmit a signal resulted from the selected CM and pass the signal of the selected CM to the CMTS, and the UCD management messages set a used frequency in a channel; and (3) causing just one of the CMs to transmit a corresponding signal to the CMTS through selected DNB at a predetermined time, wherein the programmable band pass filter reduces the upstream ingress noise in a frequency domain, and the RF switch disconnects unselected DNBs so as the upstream ingress noise is fully isolated and is passed to the CMTS in the time domain so as to achieve a high quality cable data system communication.

With the above steps, the ingress noise existed in user groups of a cable data system and returned via an upstream network would not gather and accumulate at the CMTS or the headend of the cable data system to result in deteriorated network transmission quality.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional cable data system, in which noises are returned from clients via a network to gather and accumulate at a headend of the system;

FIG. 2 is a flowchart showing the steps included in the method of reducing upstream ingress noise in cable data system according to the present invention;

FIG. 3 shows a preferred example of reducing upstream ingress noise in cable data system using the method of the present invention;

FIG. 4 is a flowchart illustrating a method of reducing upstream ingress noise in cable data system according to one of preferred embodiment of the present invention;

FIG. 5 illustrates an exemplary embodiment of a structure of DOCSIS based Ingress Noise Blocker (DNB) of reducing upstream ingress noise according to the present invention;

FIG. 6 shows an exemplary of a MAP management messages based on DOCSIS;

FIG. 7 illustrates another exemplary embodiment of reducing upstream ingress noise according to the present invention;

FIG. 8 illustrates another exemplary embodiment of reducing upstream ingress noise according to the present invention; and

FIG. 9 illustrates the other exemplary embodiment of reducing upstream ingress noise according to the present invention.

### DETAILED DESCRIPTION OF THE PREFERRED EMBODIMENTS

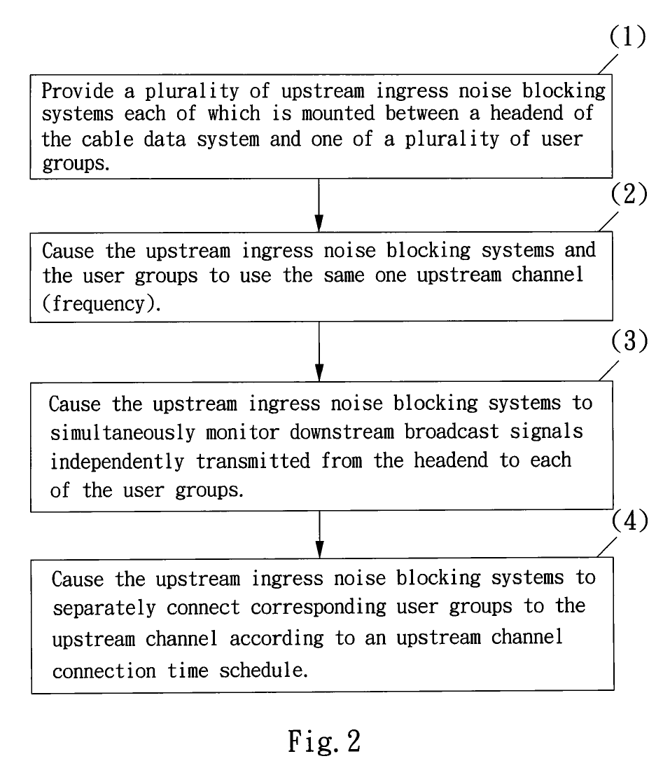

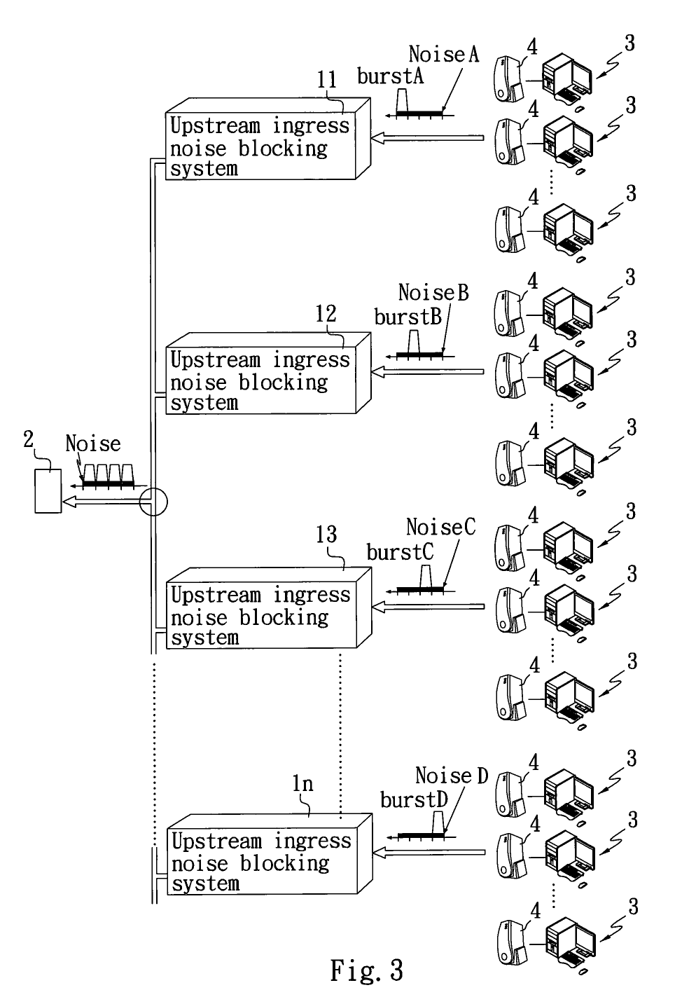

Please refer to FIG. 2 that is a flowchart showing the steps included in a method of reducing upstream ingress noise in cable data system according to the present invention, and to FIG. 3 that shows a preferred example of reducing upstream ingress noise in cable data system using the method of the present invention.

In a first step (1), a plurality of upstream ingress noise blocking systems 11-1n are provided for mounting between a headend 2, which is, for example, a cable modem termination system (CMTS), and a plurality of user groups A-D. Each of the user groups A-D includes a plurality of users, which include a plurality of electronic apparatus 3 with web connection function. The electronic apparatus 3 may include but not limited to personal computers, notebook computers, and personal digital assistants (PDA). Each user is connected via a cable modem 4 to a corresponding one of the upstream ingress noise blocking systems 11-1n.

In a second step (2), all the upstream ingress noise blocking systems 11-1n and the user groups A-D are caused to use the same one upstream channel (frequency).

In a third step (3), the upstream ingress noise blocking systems 11-1n are caused to simultaneously monitor downstream broadcast signals independently transmitted by the headend 2 to one of the user groups A-D. The downstream broadcast signals include messages about the time for each user group A-D to upload data, so that an upstream channel connection time schedule is determined for the upstream ingress noise blocking systems 11-1n and the user groups A-D. The downstream broadcast signals is either a data message or a management message, which is a management message described in DOCSIS.

The management message is further divided into three types, namely, (I) A MAP management message represented a upstream bandwidth allocation on the DOCSIS, which is the most important message describing time points, opportunities, channels available for data uploading, and corresponding service numbers. From the MAP management message, the upstream ingress noise blocking systems 11-1n are capable of knowing when the data from the user groups A-D is uploaded; (II) A SYNC management message represented a time synchronization on the DOCSIS, which is a synchronized control signal for the upstream ingress noise blocking systems 11-1n and all the user groups A-D, describes the current time at the headend 2; and (III) An UCD management message represented an upstream channel descriptor, which comprises information about the upstream channel of the cable data system, including channel number, frequency, time unit, way of numbering, burst description, etc. Based on the upstream bandwidth allocation—MAP message, the upstream ingress noise blocking systems 11-1n set the data uploading time for each user group A-D in the upstream channel connection time schedule.

In a fourth step (4), the upstream ingress noise blocking systems 11-1n are connected to the upstream channel based on the upstream channel connection time schedule, so that data from the user groups A-D may be separately uploaded to the headend 2 at uploading time of burst A, burst B, burst C, and burst D. For example, the upstream ingress noise blocking system 11 connects the upstream channel to the user group A at the data uploading time of burst A. At this point, a burst A signal will pass through the upstream ingress noise blocking system 11 to reach at the headend 2. Then, the upstream ingress noise blocking system 12 connects the upstream channel to the user group B at the data uploading time of burst B. At this point, a burst B signal will pass through the upstream ingress noise blocking system 12 to reach at the headend 2. And, the user groups C, D are separately connected to the upstream channel via the upstream ingress noise blocking systems 13, 1n in the same manner.

In this manner, upstream ingress noise being returned from the user groups A-D exists only when the user groups are connected to the upstream channel via corresponding upstream ingress noise blocking systems 11-1n at the corresponding data uploading time of burst A-D. With these arrangements, the upstream ingress noise returned via the upstream channel would not gather and accumulate at the headend 2 to adversely affect the quality of network communication.

From the above described steps (1) to (4) in the method of the present invention, it can be clearly seen that the problem of gathered and accumulated upstream ingress noise in a cable data system has been effectively improved. In brief, the method of the present invention complies with DOCSIS and advantageously reduces the upstream ingress noise in a cable data system, and may be implemented using general cable modems or similar hardware. Therefore, the present invention is novel and improved, and industrially valuable for use.

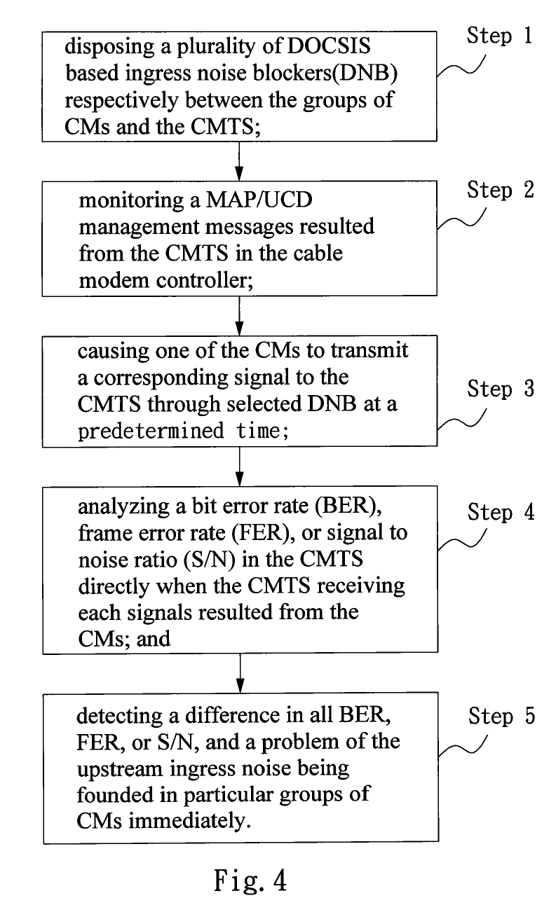

FIG. 4 is a flowchart illustrating a method of reducing upstream ingress noise in cable data system according to one of preferred embodiment of the present invention. The method is based on Cable Systems Interface Specification (DOCSIS) standard, wherein the cable data system has a plurality of groups of CMs and a CMTS, such as the CMTS may be called a Cable modem termination system (CMTS).

The above-mentioned method comprises the steps of: step 1, disposing a plurality of DOCSIS based ingress noise blockers (DNB) respectively between the groups of CMs and the CMTS, wherein each of the ingress noise blockers has a radio frequency (RF) switch, a programmable band pass filter, and a cable modem controller; step 2, monitoring a MAP/UCD management messages resulted from the CMTS in the cable modem controller, wherein the MAP management messages select one of CMs to transmit a signal resulted from the selected CM and pass the signal of the selected CM to the CMTS, in which the UCD management messages set a used frequency in a channel; and step 3, causing one of the CMs to transmit a corresponding signal to the CMTS through selected DNB at a predetermined time, wherein the programmable band pass filter reduces the upstream ingress noise in a frequency domain, and the RF switch disconnects unselected DNBs so as the upstream ingress noise is fully isolated and is passed to the CMTS so as to achieve a high quality cable data system communication.

Moreover, the method further comprises the steps of: step 4, analyzing a bit error rate (BER), frame error rate (FER), or signal to noise ratio (S/N) in the CMTS directly when the CMTS receiving each signals resulted from the CMs; and step 5, detecting a difference in all BER, FER, or S/R, and a problem of the upstream ingress noise being founded in particular groups of CMs immediately.

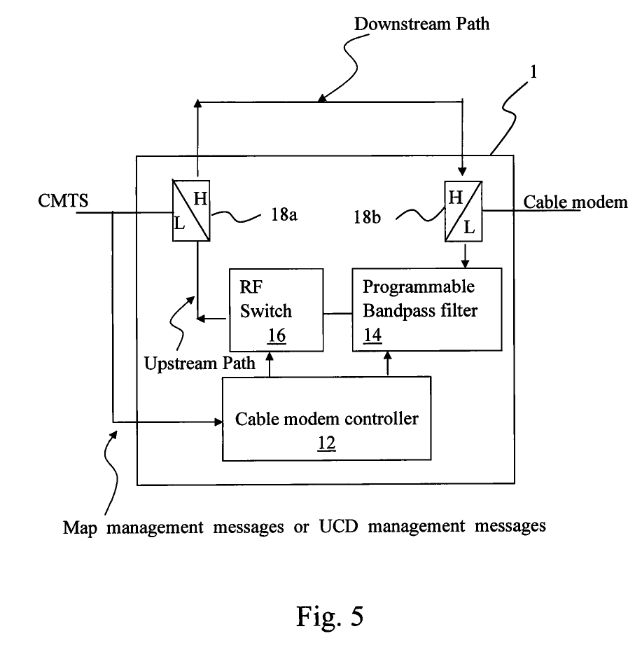

FIG. 5 illustrates an exemplary embodiment of a structure of DOCSIS based Ingress Noise Blocker (DNB) of reducing upstream ingress noise according to the present invention. In this embodiment, the structure 1 of DNB comprises a cable modem controller 12, a programmable band pass filter 14, a radio frequency switch 16, and at least two diplexers 18a, 18b.

In the cable data system, the CMTS connects the DNB and the CM via an upstream path and a downstream path, wherein the DNB divides into the upstream path and the downstream path via the diplexer 18a, 18b. Particularly, the cable modem controller 12 of the DNB is used to monitor the downstream path. In general, the downstream path utilizes a high frequency bandwidth, and the upstream path utilizes a low frequency bandwidth. When the cable data system is warm-up at the initial stage, the programmable band pass filter 14 is set a common used frequency in the frequency domain by an Upstream Channel Descriptor (UCD) management messages resulted from the CMTS via the cable modem controller 12, such as the programmable band pass filter 14 utilizes a finite impulse response (FIR) digital filter to suppress the upstream ingress noise.

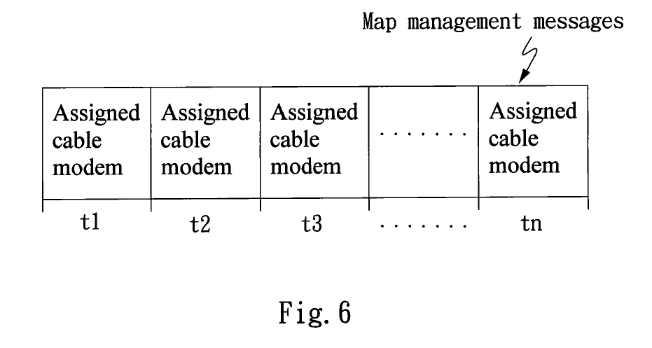

At a next stage, the cable modem controller 12 is also configured to monitor MAP management messages (as shown in FIG. 6) resulted from the CMTS in the downstream path and generates a control signal CS to set the radio frequency switch 16 simultaneously, wherein the MAP management messages is divided into a lot of mini time slots in the time domain, and each mini time slot indicates which groups of cable modems can transmit the data to the CMTS.

The DNB utilizes the RF switch 16 to determine upstream path connecting or disconnecting according to the control signal CS resulted from the modem controller 12. In another words, the RF switch 16 provides full conduction and complete isolation between the CMTS and the CM so as to achieve a high quality cable data system communication.

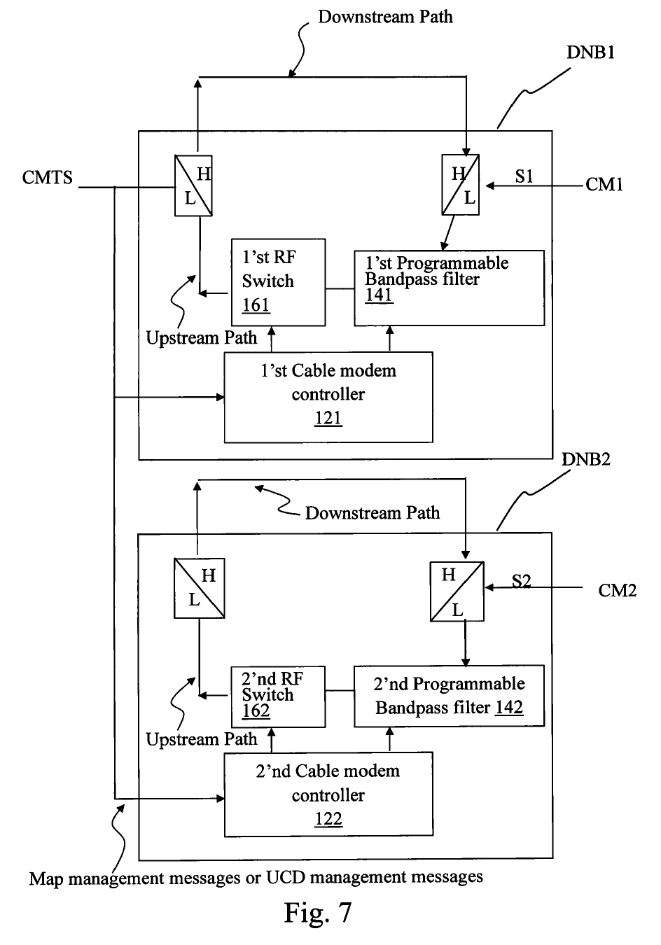

FIG. 7 illustrates another exemplary embodiment of reducing upstream ingress noise according to the present invention. At first, the first/second cable modem controller 121 sets the first/second programmable band pass filter 141, 142 as the same frequency (or channel) according to UCD management messages. The next, only the signal S1 of the first cable modem CM1 associated the first cable modem controller 121 or the signal S2 of the second cable modem CM2 associated the second cable modem controller 122 will pass to the CMTS at the time according to MAP management message. Particularly, it must be understood that the CMTS will also receive only the upstream ingress noise at the corresponding time arranged in the TDMA mode based on DOCSIS.

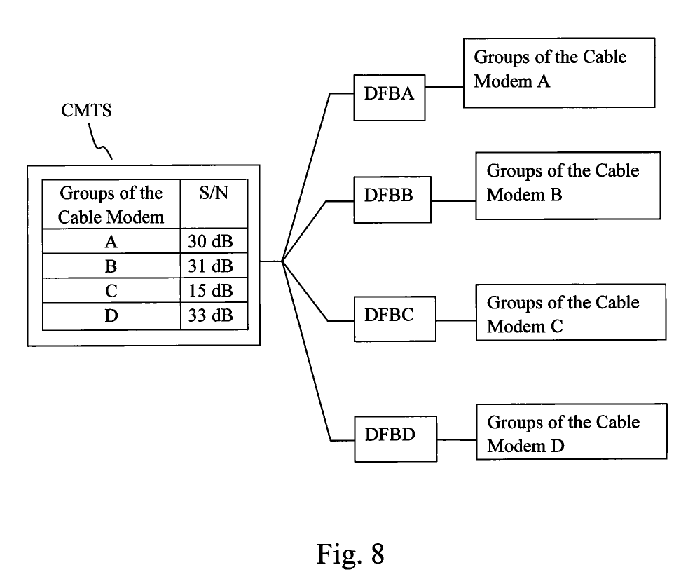

In addition, the CMTS can analyze a bit error rate (BER), a frame error rate (FER), or the signal to noise ratio (S/N) in the CMTS directly when the CMTS receives each signals resulted from the corresponding cable modem in the TDMA mode based on DOCSIS as shown in FIG. 8. The CMTS respectively records the SNR of each of the groups of cable modems (CMs) A, B, C, D into the table according to MAP management message resulted from CMTS, and the CMTS also diagnoses the quality of SNR in the table. For example, the SNR of the groups of cable modem A, B, C, D are 30 dB, 31 dB, 15 dB, 33 dB respectively, wherein the quality of SNR of the group of cable modem C is obviously worst compared with the other groups A, B, D.

After diagnosing an average of quality of SNR of all groups in the CMTS, the CMTS is able to detect/determine the upstream ingress noise occurred in a particular group of cable modem C immediately. Moreover, the upstream ingress noise occurred is only received by the CMTS in the arranged time based on DOCSIS, and the other upstream ingress noises occurred in the unarranged time are completely isolated in the corresponding DNB. Particularly, the cable data system doesn't need for special equipment in the CMTS according to the present invention, and it also achieves a quality cable data system communication.

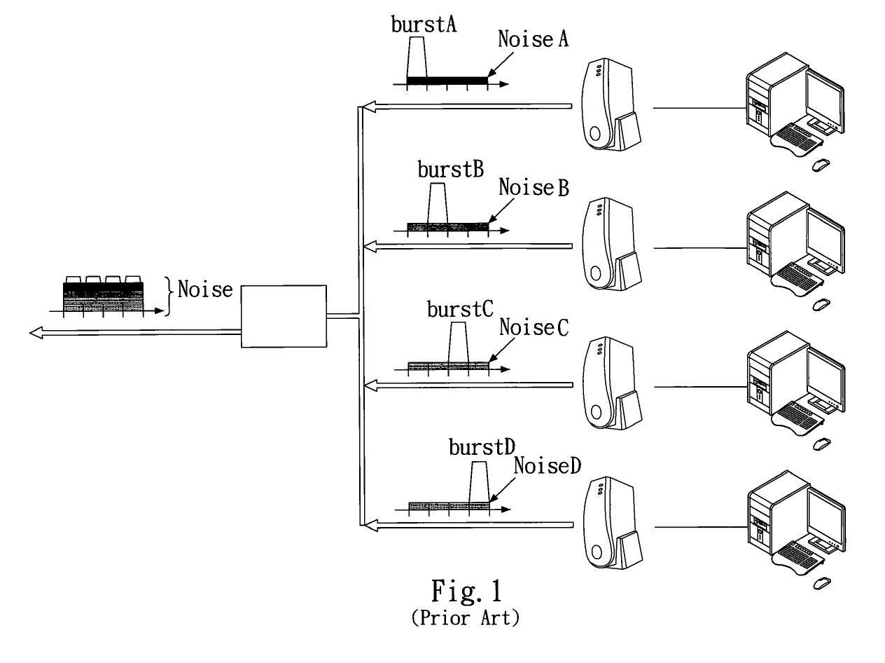

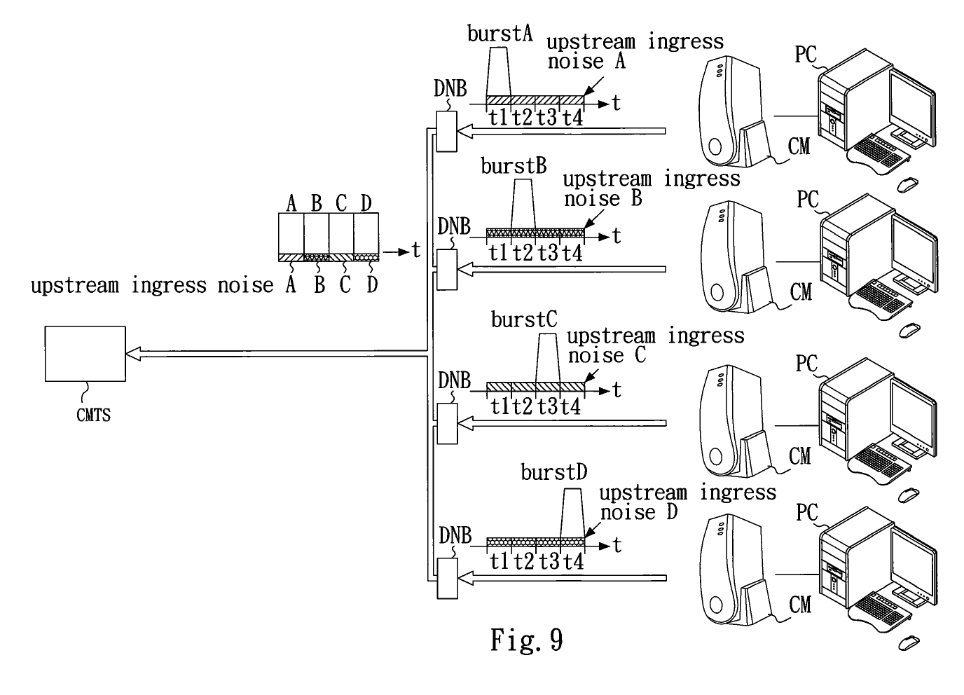

Referring to FIG. 9, it illustrates the other exemplary embodiment of reducing upstream ingress noise according to the present invention. Compare with the prior art as shown in FIG. 1, the present invention will get the high quality S/N in the CMTS, such as the burst A only accompany the upstream ingress noise A at time t1, and others burst B, C, D will be completely isolated by the corresponding DFB.

Since the present invention has a preferred isolation, the burst accompany with upstream ingress noises in the unarranged time don't influence to main burst transmitted in the arranged time. Therefore, the present invention has a preferred S/N in the high speed cable data system.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of reducing upstream ingress noise in cable data system, comprising the steps of:
(1) providing a plurality of upstream ingress noise blocking systems, each of which is mounted between a headend of the cable data system and one of a plurality of user groups;
(2) causing the upstream ingress noise blocking systems and the user groups to synchronously use an upstream channel of the headend;
(3) causing the upstream ingress noise blocking systems to simultaneously monitor downstream broadcast signals independently transmitted from the headend to each of the user groups, wherein each of the downstream broadcast signals includes information about data uploading time for a corresponding one of the user groups; and an upstream channel connection time schedule being determined for the upstream ingress noise blocking systems and the user groups based on the data uploading time for each of the user groups; and
(4) causing the upstream ingress noise blocking systems to separately connect the corresponding user groups to the upstream channel according to the upstream channel connection time schedule, so that data from each of the user groups may be uploaded to the headend.

2. The method of reducing upstream ingress noise in cable data system as claimed in claim 1, wherein the headend is a cable modem termination system (CMTS).

3. The method of reducing upstream ingress noise in cable data system as claimed in claim 1, wherein each of the user groups includes a plurality of users, and each of the users is connected to a corresponding one of the upstream ingress noise blocking systems via a cable modem.

4. The method of reducing upstream ingress noise in cable data system as claimed in claim 3, wherein the users are electronic apparatus with web connection function.

5. The method of reducing upstream ingress noise in cable data system as claimed in claim 4, wherein the electronic apparatus are selected from the group consisting of personal computers, notebook computers, and digital personal assistants (PDA's).

6. The method of reducing upstream ingress noise in cable data system as claimed in claim 1, wherein each of the downstream broadcast signals is a management message as described in DOCSIS (Data over Cable System Interface Specifications).

7. The method of reducing upstream ingress noise in cable data system as claimed in claim 6, wherein the management message includes a MAP management message represented an upstream bandwidth allocation, a SYNC management message represented a time synchronization, and UCD management message represented an upstream channel descriptor.

8. A method of reducing upstream ingress noise in cable data system, the cable data system having a plurality of groups of Cable Modems (CMs) and a Cable Modem Termination System (CMTS) based on Cable Systems Interface Specification (DOCSIS), the method comprising the steps of:
(1) disposing a plurality of DOCSIS based ingress noise blockers (DNB) respectively between the groups of CMs and the CMTS, wherein each of the ingress noise blockers has a radio frequency (RF) switch, a programmable band pass filter and a cable modem controller;
(2) monitoring a MAP/UCD management messages resulted from the CMTS in the cable modem controller, wherein the MAP management messages select one of CMs to transmit a signal resulted from the selected CM and pass the signal of the selected CM to the CMTS, and the UCD management messages set a common used frequency in a channel; and
(3) causing one of the CMs to transmit a corresponding signal to the CMTS through selected DNB at a predetermined time, wherein the programmable band pass filter reduces the upstream ingress noise in a frequency domain, and the RF switch disconnects unselected DNBs so as the upstream ingress noise is fully isolated and is passed to the CMTS in order to achieve a high quality cable data system communication.

9. The method according to claim 8, further comprising:
(4) analyzing directly a bit error rate (BER), a frame error rate (FER), or a signal to noise ratio (S/N) in the CMTS when the CMTS is receiving each signals resulted from the CMs; and
(5) detecting a difference in all the BER, FER, or S/N, and a problem of the upstream ingress noise being founded in particular groups of CMs immediately.
